(19) United States
(12) Patent Application Publication
(10) Pub. No.: US 2006/0292542 A1
(43) Pub. Date: Dec. 28, 2006

(54) Interactive system and method for partner-based education and training

(75) Inventor: Jeffrey S. Levy, Philadelphia, PA (US)

Correspondence Address: DRINKER BIDDLE & REATH;ATTN: INTELLECTUAL PROPERTY GROUP, ONE LOGAN SQUARE, 18TH AND CHERRY STREETS, PHILADELPHIA, PA, 19103-6996, US

(73) Assignee: Reflective Learning LLC

(21) Appl. No.: 11/472,187

(22) Filed: Jun. 21, 2006

Related U.S. Application Data
(60) Provisional application No. 60/693,291, filed on Jun. 23, 2005.

(51) Int. Cl. G09B 3/00

(52) U.S. Cl. 434/350; 434/362

(57) ABSTRACT

Provided is a computer-implemented interactive system and method for educating or training one or more participating users on a topic that includes a graphical user interface for delivering core content to the participating users. One or more icons are provided on the graphical user interface, each of which corresponds to a potential partner for the participating users with respect to core content. During a segment of the core content, a participating user selects one or more potential partners to assist the participating user regarding core content being delivered by a lecturer or discussion leader, by clicking on one of the icons on the graphical user interface (or partner content can be pre-associated with core content and provided in-line with core content as part of content session). The partner has past experience, characteristics or is in a position that causes the participating user to identify with the selected partner.

### CROSS-REFERENCE TO RELATED APPLICATIONS

This application claims priority to U.S. Provisional Patent Application, No. 60/693,291 filed on Jun. 23, 2005, and herein incorporates by reference in its entirety.

### BACKGROUND

Distance learning relates to a learning format where the participating user is physically separated from the instructor. Currently, the Internet and other electronic platforms are used to provide various distance learning formats and applications, including formats where a video stream of a lecturer is provided to the participating user remotely over the Internet. Participating users access the video stream using their own computers via a central server sponsored by the provider of the distance learning program. Each participating user accessing the central server may watch the lecture from their own computer, typically at a time that is convenient for the participating user.

Although existing distance learning solutions are useful for efficiently reaching large numbers of participating users, these solutions do not always represent an effective tool for training or educating participating users. In particular, existing distance learning solutions are deficient because the participating user may not identify with the lecturer shown in the video stream, and it is not possible to have smaller break-out groups for peer-to-peer learning in prior art distance learning formats. As a result, participating users using existing distance learning formats fail to adequately absorb the content or message of the lecture. It would be advantageous to provide a distance learning solution that overcomes the shortcomings of existing practices.

### SUMMARY

The herein described systems and methods provide a computer-implemented interactive platform for educating or training one or more participating users on a topic. A graphical user interface is provided in order to deliver core content relating to the topic to the participating users. The core content can comprise a knowledge base to be delivered to the participating users and, in some embodiments, includes one or more skill building activities. The core content can be delivered, via the graphical user interface, from a lecturer or discussion leader to each of the participating users. One or more icons can be provided on the graphical user interface. Each icon can correspond to a potential partner for the participating users with respect to core content delivered by the lecturer or discussion leader. In an illustrative operation, during a segment of the core content, a participating user can select one of the plurality of potential partners to assist the participating user with respect to understanding core content delivered by the lecturer or discussion leader, by clicking on one of the icons on the graphical user interface. In another illustrative implementation, partner content (i.e., content provided by a partner) may be provided in-line with the core content, without the participating user making a selection for a partner. In this implementation, the session content (i.e., core content and partner content) is provided in one seamless session.

In an illustrative implementation, the selected partner can have past experience, characteristics or is in a position that causes the participating user to identify with the selected partner with respect to the core content. In response to the selection of the icon by the participating user, content from the selected partner can be delivered to the participating user via the graphical user interface. The content from the selected partner can correspond to views or experience of the selected training partner with respect to the core content delivered by the lecturer or discussion leader, and may provide one or more different perspectives to reinforce material from the knowledge base already learned by the participating user.

In an illustrative implementation, the core content can be delivered to each participating user during one or more time segments, each of which can be used to address a different subject included in the core content. The content delivered to the participating user from the partner can vary based on both the potential partner selected by the participating user and the subject being addressed by the lecturer or discussion leader during the time segment in which the participating user selects the potential partner.

Depending upon the topic or format of the core content, the potential partner selected by the participating user can correspond, for example, to a coach, an expert, a business professional, an employee, a supervisor, a military officer or a consumer. The potential partner can correspond to a virtual partner, or a person that the participating user interacts with remotely in real time during the educating or training session.

Additional features, objects and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

The interactive systems and methods for partner-based education and training are further described with reference to the accompanying drawings in which:

FIG. 1 is a block diagram of an exemplary computing environment in accordance with an implementation of the herein described systems and methods.

FIG. 2 is a block diagram showing the cooperation of exemplary components of an illustrative implementation in accordance with the herein described systems and methods.

FIG. 3 is a block diagram showing the cooperation of exemplary components of another illustrative implementation in accordance with the herein described systems and methods.

FIG. 4 is a block diagram showing an illustrative block representation of an illustrative interactive training system in accordance with the herein described systems and methods.

FIG. 4A is a block diagram showing the illustrative block representation of FIG. 4 with an illustration of the data store with content sessions and character data directed to youth.

FIG. 5 is a flow diagram of the processing performed in an illustrative operation in accordance with the herein described systems and methods.

FIG. 5A is a flow diagram of the process shown in FIG. 5 with the addition of an illustration of the processing performed with content sessions directed to youth.

FIG. 6 is a screen shot of an illustrative user interface having features and operations in accordance with the herein described systems and methods.

FIG. 7 is a screen shot of an illustrative user interface having features and operations in accordance with the herein described systems and methods.

FIG. 8 is a screen shot of an illustrative user interface having features and operations in accordance with the herein described systems and methods.

FIG. 9 is a screen shot of an illustrative user interface having features and operations in accordance with the herein described systems and methods.

FIG. 10 is a screen shot of an illustrative user interface having features and operations in accordance with the herein described systems and methods.

FIG. 11 is a screen shot of an illustrative user interface having features and operations in accordance with the herein described systems and methods.

FIG. 12 is a screen shot of an illustrative user interface having features and operations in accordance with the herein described systems and methods.

FIG. 13 is a screen shot of an illustrative user interface having features and operations in accordance with the herein described systems and methods.

FIG. 14 is a screen shot of an illustrative user interface having features and operations in accordance with the herein described systems and methods.

FIG. 15 is a screen shot of an illustrative user interface having features and operations in accordance with the herein described systems and methods.

FIG. 16 is a screen shot of an illustrative user interface having features and operations in accordance with the herein described systems and methods.

FIG. 17 is a screen shot of an illustrative user interface having features and operations in accordance with the herein described systems and methods.

FIG. 18 is a screen shot of an illustrative user interface having features and operations in accordance with the herein described systems and methods.

FIG. 19 is a screen shot of an illustrative user interface having features and operations in accordance with the herein described systems and methods.

FIG. 20 is a screen shot of an illustrative user interface having features and operations in accordance with the herein described systems and methods.

FIG. 21 is a screen shot of an illustrative user interface having features and operations in accordance with the herein described systems and methods.

FIG. 22 is a screen shot of an illustrative user interface having features and operations in accordance with the herein described systems and methods.

FIG. 23 is a screen shot of an illustrative user interface having features and operations in accordance with the herein described systems and methods.

FIG. 24 is a screen shot of an illustrative user interface having features and operations in accordance with the herein described systems and methods.

FIG. 25 is a screen shot of an illustrative user interface having features and operations in accordance with the herein described systems and methods.

FIG. 26 is a screen shot of an illustrative user interface having features and operations in accordance with the herein described systems and methods.

FIG. 27 is a screen shot of an illustrative user interface providing an exemplary interactive virtual three dimensional environment for delivering content sessions directed to youth in accordance with the herein described systems and methods.

FIG. 28 is a screen shot of an illustrative user interface providing an exemplary interactive environment for delivering content sessions directed to youth in accordance with the herein described systems and methods.

### DETAILED DESCRIPTION

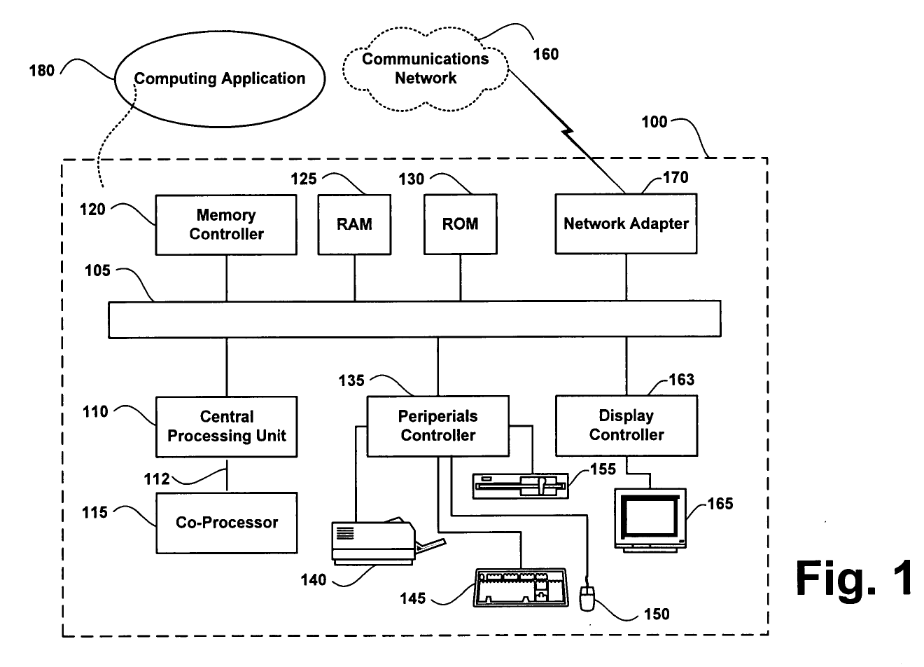

FIG. 1 depicts an exemplary computing system 100 in accordance with herein described system and methods. Computing system 100 is capable of executing a variety of computing applications 180. Computing application 180 can comprise a computing application, a computing applet, a computing program and/or other instruction set operative on computing system 100 to perform at least one function, operation, and/or procedure. Exemplary computing system 100 is controlled primarily by computer readable instructions, which may be in the form of software. The computer readable instructions can contain instructions for computing system 100 for storing and accessing the computer readable instructions themselves. Such software may be executed within central processing unit (CPU) 110 to cause the computing system 100 to do work. In many known computer servers, workstations and personal computers CPU 110 is implemented by micro-electronic chips, CPUs called microprocessors. A coprocessor 115 is an optional processor, distinct from main CPU 110 that performs additional functions or assists CPU 110. CPU 110 may be connected to coprocessor 115 through interconnect 112. One common type of coprocessor is the floating-point coprocessor, also called a numeric or math coprocessor, which is designed to perform numeric calculations faster and better than the general-purpose CPU 110.

In operation, CPU 110 fetches, decodes, and executes instructions, and transfers information to and from other resources via the computer's main data-transfer path, system bus 105. Such a system bus connects the components in computing system 100 and defines the medium for data exchange. Memory devices coupled to system bus 105 include random access memory (RAM) 125 and read only memory (ROM) 130. Such memories include circuitry that allows information to be stored and retrieved. ROMs 130 generally contain stored data that cannot be modified. Data stored in RAM 125 can be read or changed by CPU 110 or other hardware devices. Access to RAM 125 and/or ROM 130 may be controlled by memory controller 120. Memory controller 120 may provide an address translation function that translates virtual addresses into physical addresses as instructions are executed.

In addition, computing system 100 can contain peripherals controller 135 responsible for communicating instructions from CPU 110 to peripherals, such as, printer 140, keyboard 145, mouse 150, and data storage drive 155. Display 165, which is controlled by a display controller 163, is used to display visual output generated by the computing system 100. Such visual output may include text, graphics, animated graphics, and video. Display controller 163 includes electronic components required to generate a video signal that is sent to display 165. Further, computing system 100 can contain network adaptor 170 which may be used to connect computing system 100 to an external communication network 160.

Illustrative Computer Network Environment:

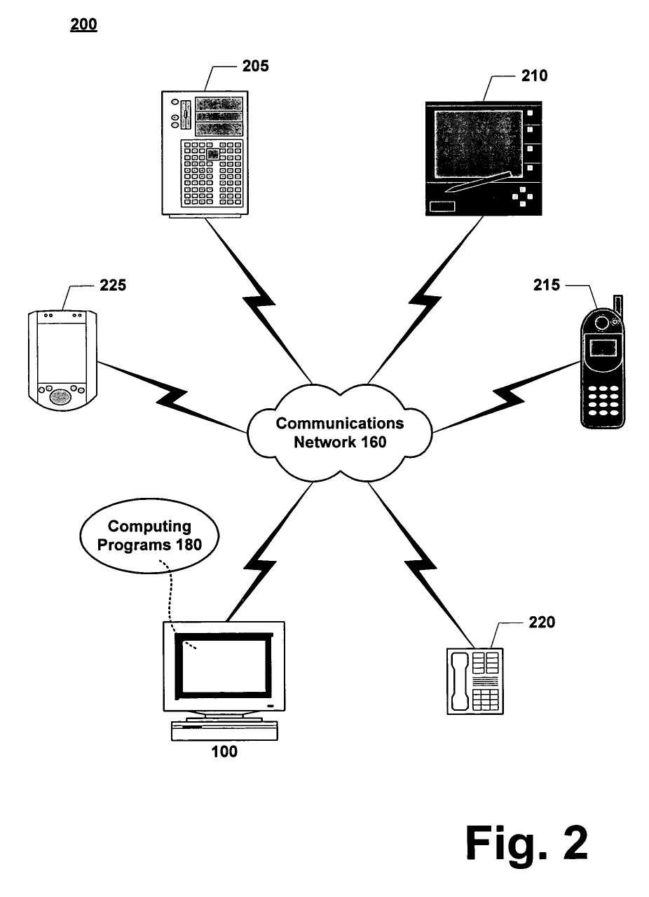

Computing system 100, described above, can be deployed as part of a computer network. In general, the above description for computing environments applies to both server computers and client computers deployed in a network environment. FIG. 2 illustrates an exemplary illustrative networked computing environment 200, with a server in communication with client computers via a communications network, in which the herein described apparatus and methods may be employed. As shown in FIG. 2, server 205 may be interconnected via a communications network 160 (which may be either of, or a combination of a fixed-wire or wireless LAN, WAN, intranet, extranet, peer-to-peer network, the Internet, or other communications network) with a number of client computing environments such as tablet personal computer 210, mobile telephone 215, telephone 220, personal computer 100, and personal digital assistance 225. In a network environment in which communications network 160 is the Internet, for example, server 205 can be dedicated computing environment servers operable to process and communicate data to and from client computing environments 100, 210, 215, 220, and 225 via any of a number of known protocols, such as, hypertext transfer protocol (HTTP), file transfer protocol (FTP), simple object access protocol (SOAP), or wireless application protocol (WAP). Each client computing environment 100, 210, 215, 220, and 225 can be equipped with browser operating system 180 operable to support one or more computing applications such as a web browser (not shown), or a mobile desktop environment (not shown) to gain access to server computing environment 205.

In operation, a participating user (not shown) may interact with a computing application running on a client computing environments to obtain desired data and/or computing applications. The data and/or computing applications may be stored on server computing environment 205 and communicated to cooperating participating users through client computing environments 100, 210, 215, 220, and 225, over exemplary communications network 160. A participating user may request access to specific data and applications housed in whole or in part on server computing environment 205. These data may be communicated between client computing environments 100, 210, 215, 220, and 220 and server computing environments for processing and storage. Server computing environment 205 may host computing applications, processes and applets for the generation, authentication, encryption, and communication of web services and may cooperate with other server computing environments (not shown), third party service providers (not shown), network attached storage (NAS) and storage area networks (SAN) to realize such web services transactions.

Interactive Partner-Based Training:

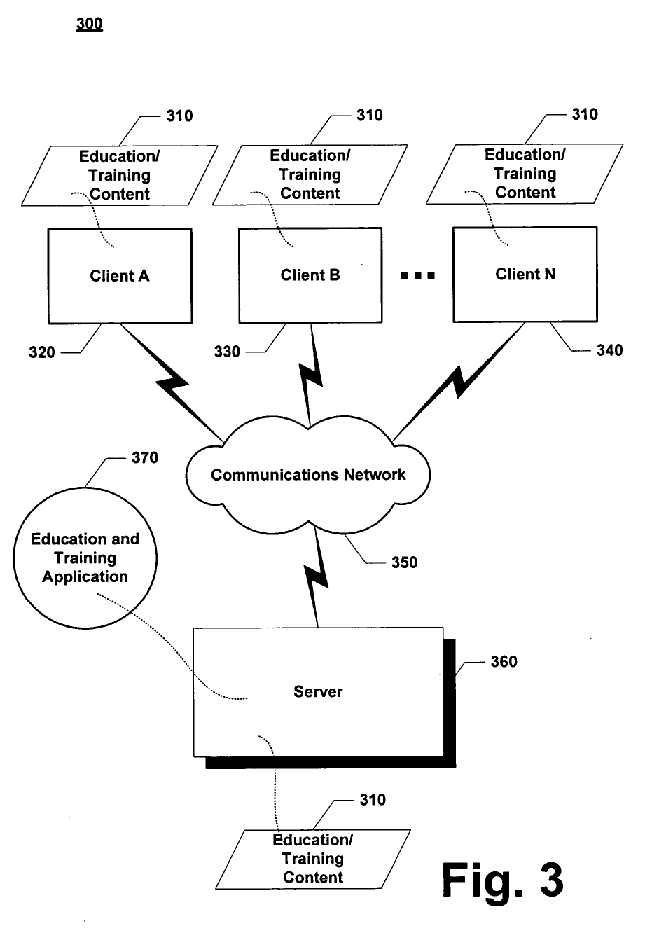

FIG. 3 shows an illustrative implementation of exemplary partner-based training environment 300 (“Partner-based” training means the system and methods for training participating users, as described above. As is shown in FIG. 3, exemplary partner-based training environment comprises client computing environment 320, client computing environment 330 up to and including client computing environment 340, communications network 350, server computing environment 360, education and training application 370, and education/training content 310.

In an illustrative operation, client computing environments 320, 330, and 340 communicate with server computing environment 360 over communications network 350 to provide requests for and receive education/training content 310. In the illustrative operation, education and training application 370 operates on server computing environment 360 to provide one or more instructions to server computing environment 360 to process requests for education/training content 310 and to provide education/training content 310 to the requesting client computing environment (e.g., client computing environment 320, client computing environment 330, or client computing environment 340). Also, as is shown in FIG. 3, client computing environments 320, 330, and 340 are capable of processing education/training content 310 for display and interaction to one or more participating users (participating users not shown).

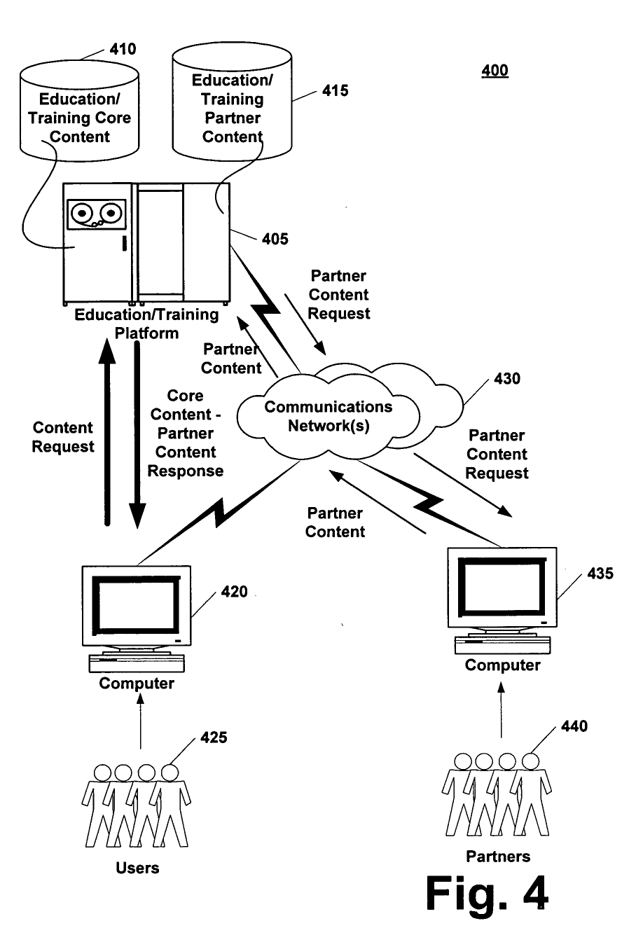

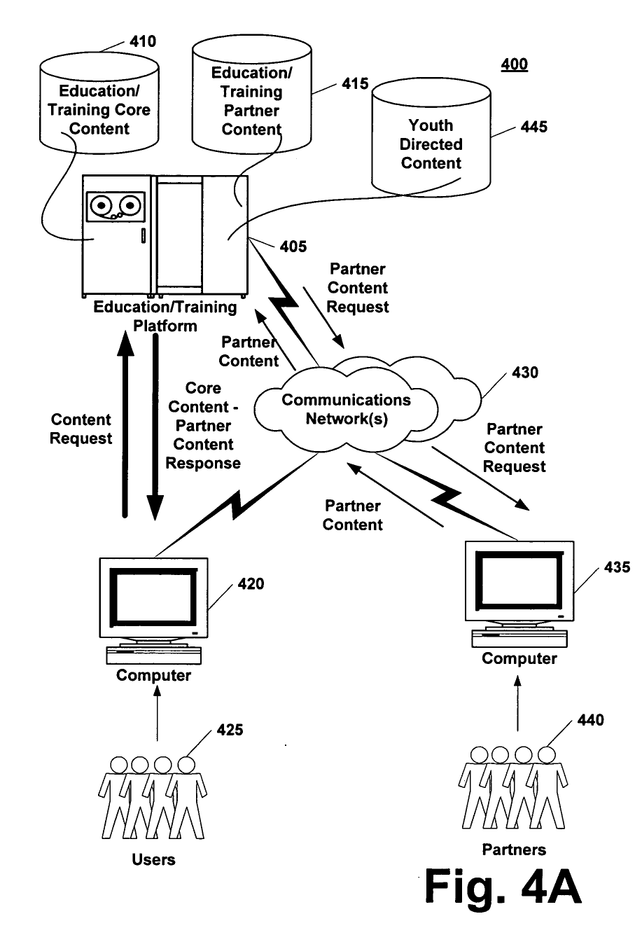

FIG. 4 shows a detailed illustrative implementation of exemplary partner-based training environment 400. As is shown in FIG. 4, exemplary partner-based training environment 400 comprises education/training platform 405, education/training core content data store 410, education/training partner content data store 415, communications network 430, computer environment 420, participating users 425, partner computing environment 435, and partners 440.

In an illustrative implementation, education/training platform is electronically coupled to computing environment 420 and computing environment 435 via communications network 430. In the illustrative implementation, communications network comprises fixed-wire and/or wireless intranets, extranets, and Internet.

In an illustrative operation, participating users 425 interact with a computing application (not shown) operating on computing environment 420 to provide requests for education/training content that are passed across communications network 430 to education/training platform 405. In the illustrative operation, education/training platform 405 process requests for education/training content and retrieve education/training core content from education/training core content data store 410. Additionally, as part of processing, education/training platform 405 identifies if there is any education/training partner content that is to be associated to the retrieved education/training core content retrieved from education/training core content data store 410. If there is associated education/training partner content, education/training platform 404 operates to retrieve education/training partner content from education/training partner content data store 415 as part of processing the described requests. In the illustrative implementation, partner content can be separate from core content, and/or can consist a portion of core content, such that partner content is presented to participating users in-line with core content.

In the illustrative operation, responsive to the requests from participating users 425 for education/training content, education/training platform 405 assembles core content and/or partner content for communication to participating users through communications network 430. The retrieved core and/or partner content is then displayed on computing environment 420 for interaction by participating users 425. If participating users interact with the core and/or partner content, a computing application (not shown) operating on computing environment 420 cooperates with education/training platform 405 to retrieve additional core and/or partner content from education/training core content data store 410 and/or education/training partner content data store 415.

Also as is shown, in the illustrative operation, education/training platform 405 cooperates with partner computing environment 435 and partners using partner computing environment 435 to obtain partner content as part of processing requests for education/training content. The cooperation between education/training platform 405 can be passive and/or active, such that in the passive context partner content can be obtained prior to processing requests and stored in education/training partner content data store 415 (e.g., multimedia files—video/audio, electronic documents, presentations, etc.). In the active context, education/training platform 405 can cooperate with partner computing environment 435 to obtain partner content in real time from partners (e.g., online chat, instant messaging, web streaming, video conferencing, etc.) as part of processing requests for education/training content.

FIG. 4A shows a detailed illustrative implementation of exemplary partner-based training environment 400 of FIG. 4, with the addition of youth content data store 445. Youth content data store 445 contains youth core content, youth partner content, and character information utilized to deliver youth core and partner content.

In an illustrative operation, participating users 425 interact with a computing application (not shown) operating on computing environment 420 to provide requests for education/training content that are passed across communications network 430 to education/training platform 405. In the illustrative operation, education/training platform 405 processes requests for education/training content and retrieve education/training core content from education/training core content data store 410. Additionally, as part of processing, education/training platform 405 identifies if there is any education/training partner content that is to be associated to the retrieved education/training core content retrieved from education/training core content data store 410. If there is associated education/training partner content, education/training platform 405 operates to retrieve education/training partner content from education/training partner content data store 415 as part of processing the described requests. Moreover, as part of processing, education/training platform 405 identifies if there is any youth directed content. If there is youth directed content, education/training platform 405 operates to retrieve from youth directed content data store 445 as part of processing the described requests.

In the illustrative operation, responsive to the requests from participating users 425 for education/training content, education/training platform 405 assembles core content and/or partner content for communication to participating users through communications network 430. The retrieved core and/or partner content is then displayed on computing environment 420 for interaction by participating users 425. If participating users interact with the core and/or partner content, computing application (not shown) operating on computing environment 420 cooperates with education/training platform 405 to retrieve additional core and/or partner content from education/training core content data store 410 and/or education/training partner content data store 415. Similarly, if participating users interact with the youth directed content, computing application (not shown) operating on computing environment 420 cooperates with education/training platform 405 to retrieve additional youth directed content from youth directed content data store 445.

Also as is shown, in the illustrative operation, education/training platform 405 cooperates with partner computing environment 435 and partners using partner computing environment 435 to obtain partner content as part of processing requests for education/training content. The cooperation between education/training platform 405 can be passive and/or active, such that in the passive context partner content can be obtained prior to processing requests and stored in education/training partner content data store 415 (e.g., multimedia files—video/audio, electronic documents, presentations, etc.). In the active context, education/training platform 405 can cooperate with partner computing environment 435 to obtain partner content in real time from partners (e.g., online chat, instant messaging, web streaming, video conferencing, etc.) as part of processing requests for education/training content. Similarly, the cooperation between education/training platform 405 can be passive and/or active such that in the passive context youth directed partner content can be obtained prior to processing requests and stored in education/training youth directed content data store 445 (e.g., multimedia files—video/audio, electronic documents, presentations, etc.). In the active context, education/training platform 405 can cooperate with partner computing environment 435 to obtain youth directed partner content in real time from partners (e.g., online chat, instant messaging, web streaming, video conferencing, etc.) as part of processing requests for education/training content.

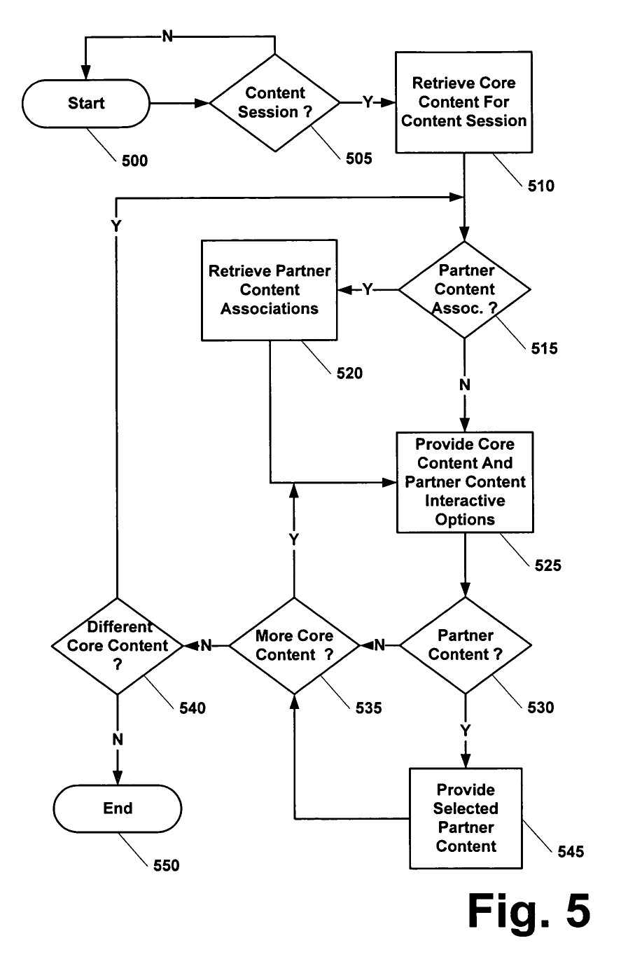

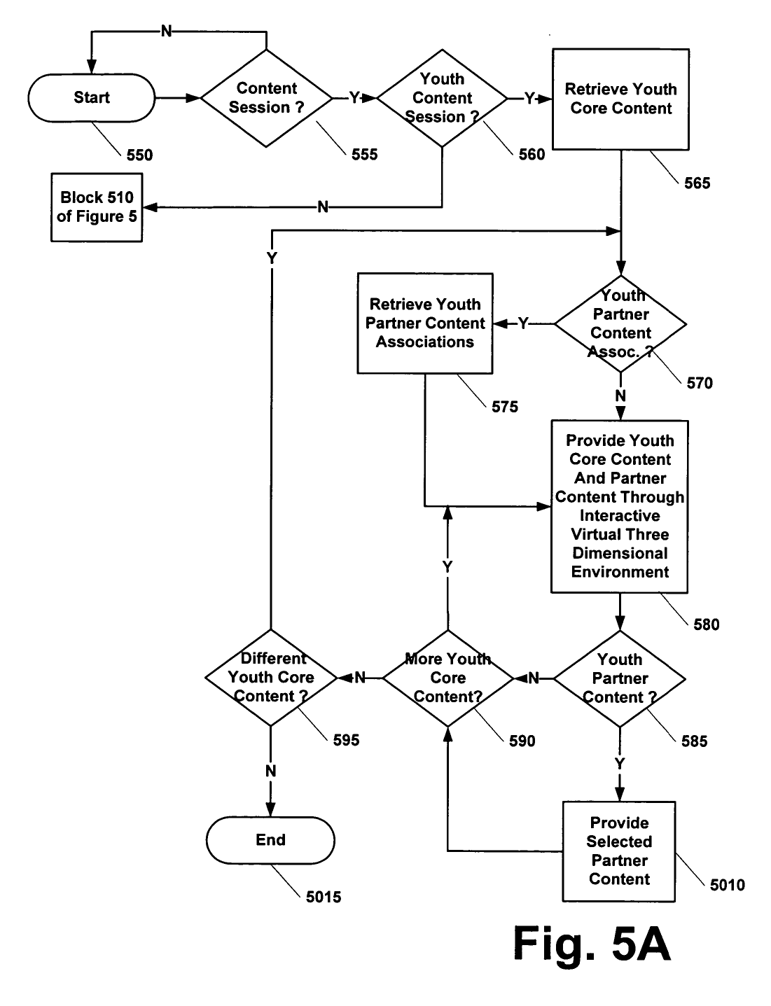

FIG. 5 shows exemplary processing performed by an illustrative implementation of exemplary partner-based training environment 400 of FIG. 4. As is shown, processing begins at block 500 and proceeds to block 505, where a check is performed to determine if a content session has been established. If the check at block 505 indicates that a content session has not been established, processing reverts back to block 500 and proceeds from there. However, if at block 505 the check indicates that a content session has been established, processing proceeds to block 510, where core content for the content session is retrieved.

A check is then performed at block 515 to determine if there are any partner content associations with the retrieved core content. If the check at block 515 indicates that there are one or more partner content associations, processing proceeds to block 520, where the partner content associations are retrieved. Conversely, if at block 515 the check indicates that there are no partner content associations for the retrieved core content, processing proceeds to block 525 and proceeds from there. From block 515, processing proceeds to block 525, where the retrieved original core content along with the identified partner content is provided to the participating user such that the core and/or partner content contains interactive mechanisms to allow participating users to select core and/or partner content.

A check is then performed at block 530 to determine if one or more partner content (i.e., associated to the core content) has been selected by a participating user. If the check at block 530 determines that partner content has been selected, processing proceeds to block 545, where the selected partner content is provided to the participating user (e.g., live interactive media presentation by an expert on one or more subjects related to the core content). Conversely, if the check at block 530 indicates that partner content has not been selected, processing proceeds to block 535. From block 530 processing proceeds to block 535, where a check is performed to determine if a participating user has selected to interact with some of the initially retrieved core content. If the check at block 535 determines that additional originally selected core content has been selected by the participating user, processing proceeds to block 525 and proceeds from there.

If, however, the check at block 535 indicates that more of the originally retrieved content has not been selected, processing proceeds to block 540 where a check is performed to determine if new core content has been selected. If the check at block 540 indicates that new original core content has been selected, processing reverts to block 515 and proceeds from there. However, if at block 540 it is determined that new core content has not been selected, processing proceeds to block 550 and terminates.

FIG. 5A shows exemplary processing performed by an illustrative implementation of exemplary partner-based training environment 400 of FIG. 4A. As is shown, processing begins at block 550 and proceeds to block 555, where a check is performed to determine if a content session has been established. If the check at block 555 indicates that a content session has not been established, processing reverts back to block 550 and proceeds from there. However, if at block 555 the check indicates that a content session has been established, processing proceeds to block 560, where a check is performed to determine whether there are any youth content sessions. If the check at block 560 indicates that there is no youth content, processing proceeds to block 510 of FIG. 5 and proceeds from there.

However, if the check at block 560 indicates that there are one or more youth core content sessions, processing proceeds to block 565, where youth core content for the youth content session is retrieved. A check is then performed at block 570 to determine if there are any youth partner content associations with the retrieved youth core content. If the check at block 570 indicates that there are one or more youth partner content associations, processing proceeds to block 575, where the youth partner content associations are retrieved. Conversely, if at block 570 the check indicates that there are no youth partner content associations for the retrieved youth core content, processing proceeds to block 580 and proceeds from there. From block 570, processing proceeds to block 580, where the retrieved original youth core content, along with the identified youth partner content is provided to the participating user, such that the youth core and/or youth partner content contains interactive mechanisms to allow participating users to select youth core and/or youth partner content through an interactive virtual three dimensional environment.

A check is then performed at block 585 to determine if one or more youth partner content (i.e., associated to the youth core content) has been selected by a participating user. If the check at block 585 determines that youth partner content has been selected, processing proceeds to block 5010 where the selected youth partner content is provided to the participating user (e.g., live interactive media presentation by an expert on one or more subjects related to the youth core content). Conversely, if the check at block 585 indicates that youth partner content has not been selected, processing proceeds to block 590. From block 585, processing proceeds to block 590, where a check is performed to determine if a participating user has selected to interact with some of the initially retrieved youth core content. If the check at block 590 determines that additional originally selected youth core content has been selected by the participating user, processing proceeds to block 580 and proceeds from there.

If, however, the check at block 590 indicates that more of the originally retrieved youth content has not been selected, processing proceeds to block 595 where a check is performed to determine if new youth core content has been selected. If the check at block 595 indicates that new original youth core content has been selected, processing reverts to block 570 and proceeds from there. However, if at block 595 it is determined that new youth core content has not been selected, processing proceeds to block 5015 and terminates.

The herein described systems and methods provide for the delivery of interactive education, that can be personalized for a variety of audiences, and that facilitates the development of self-directed educational services delivered over the Internet and other electronic platforms such as CD ROM platforms. In an illustrative implementation, the herein described systems and methods include an integrated interactive instructional format for delivering superior distance learning, such as an interactive network-based computing application. The computing application is scalable to thousands (or even millions) of participating users throughout the world, and has a content delivery cost that represents a fraction of traditional methods.

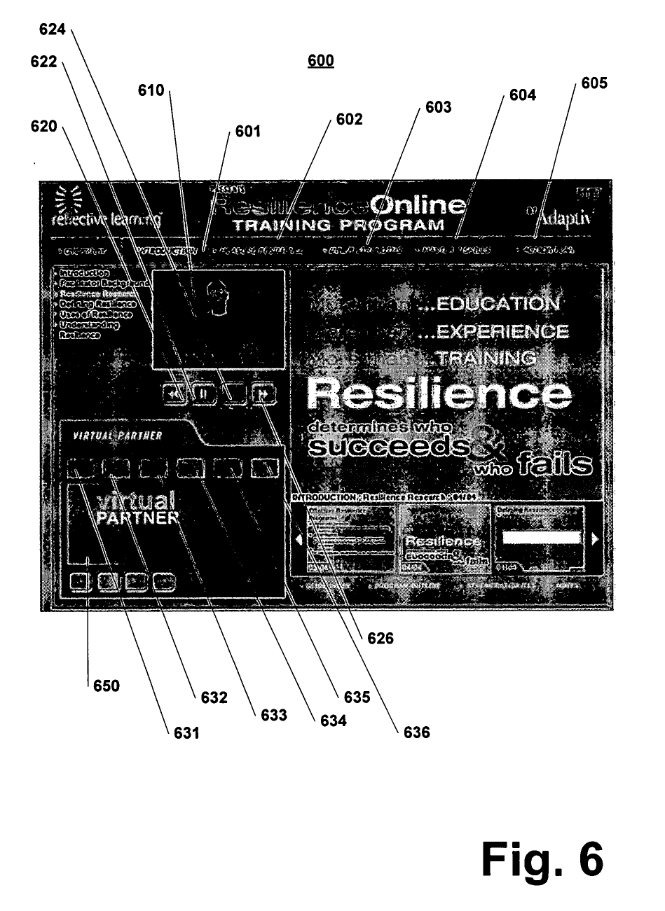

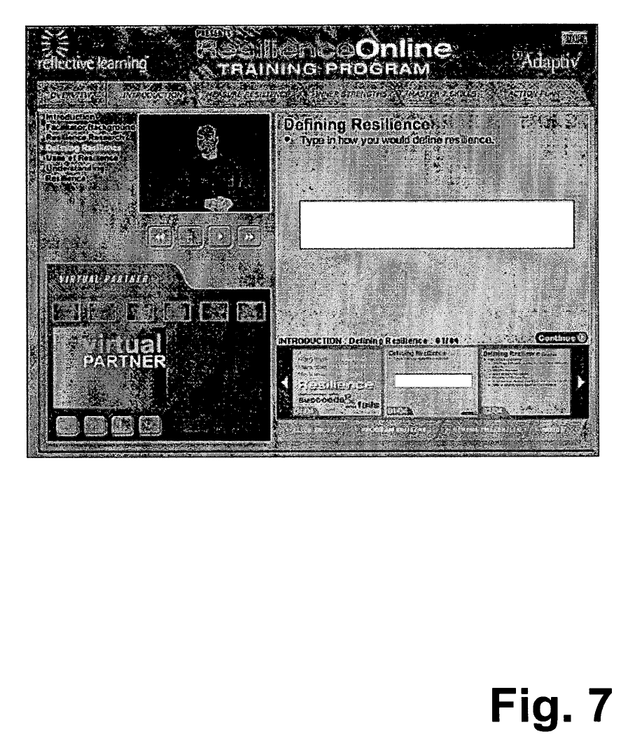

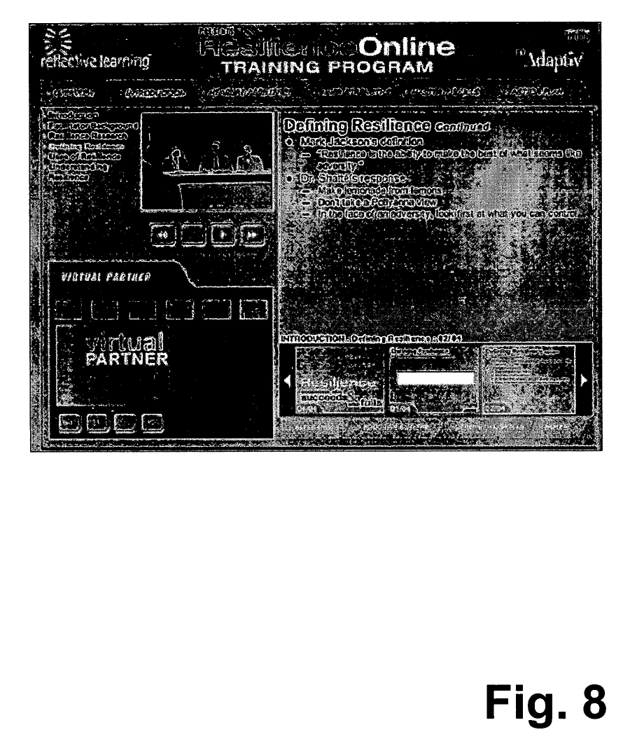

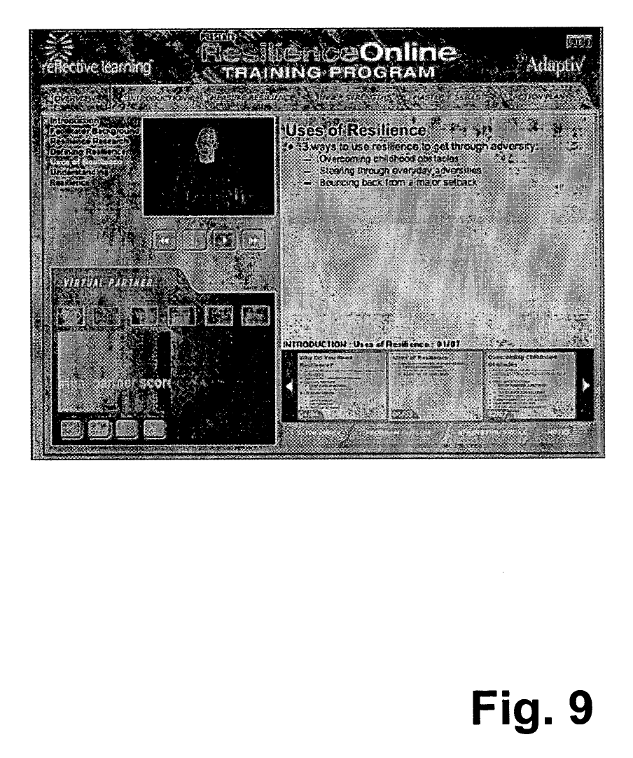

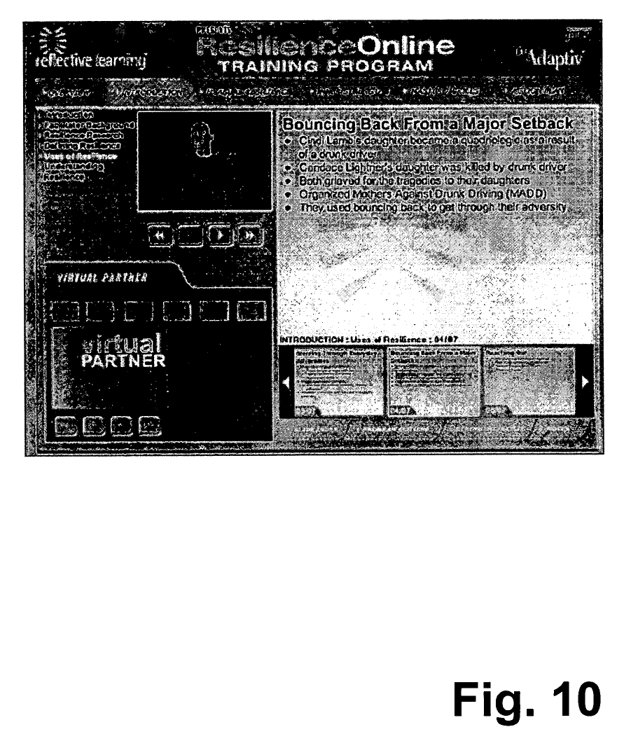

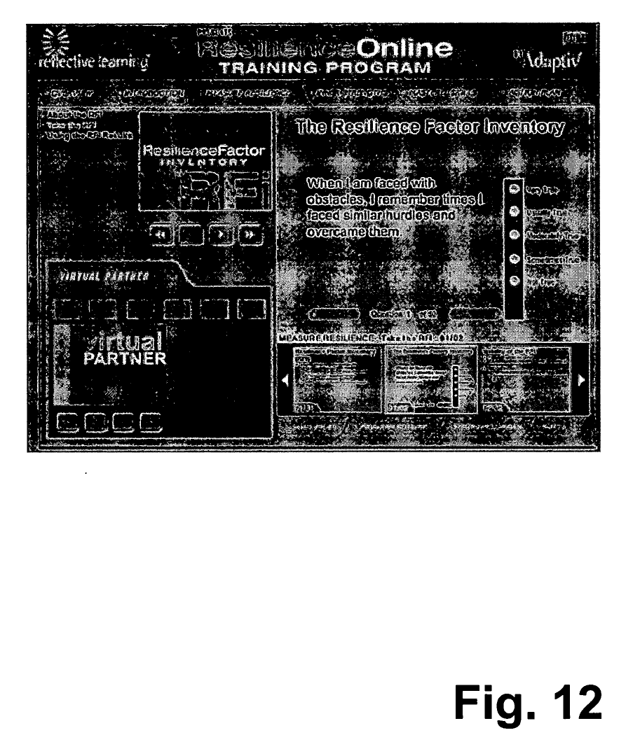

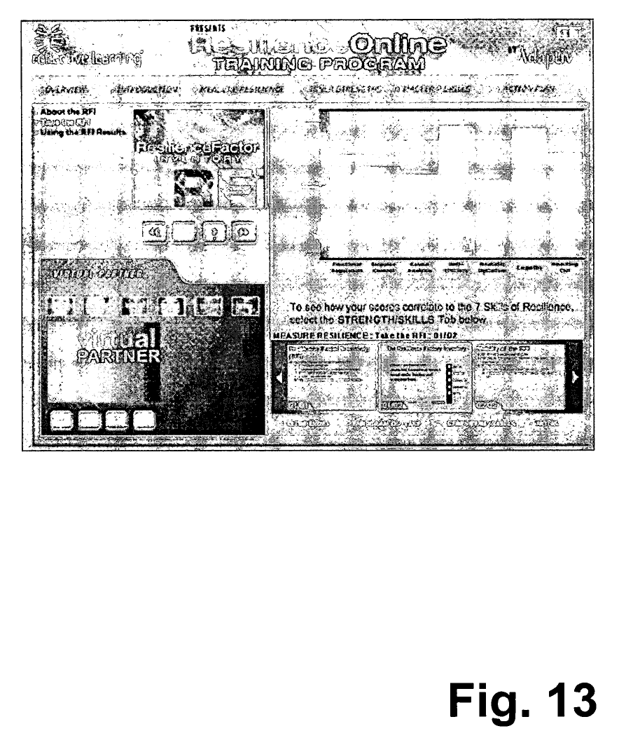

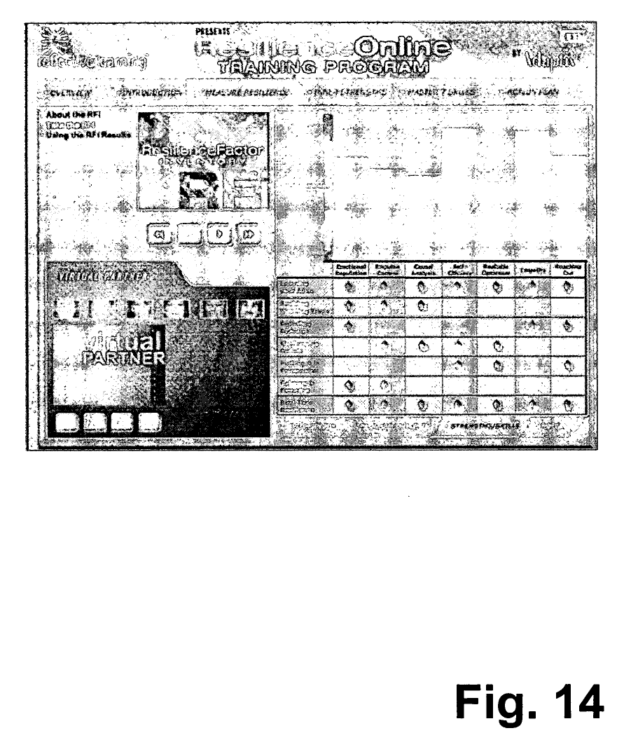

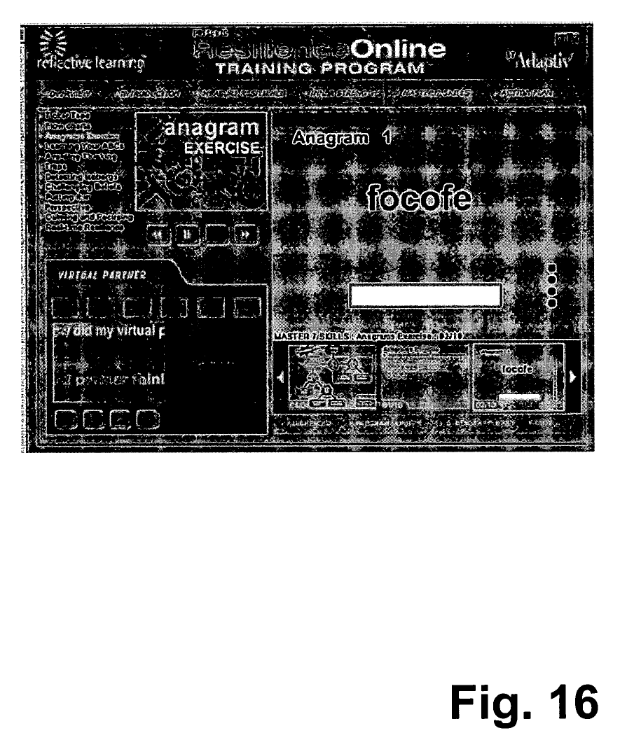

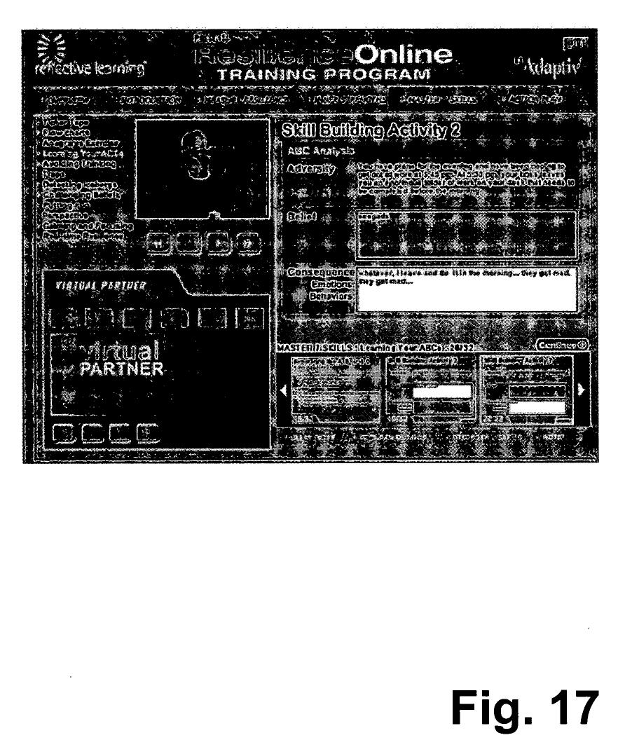

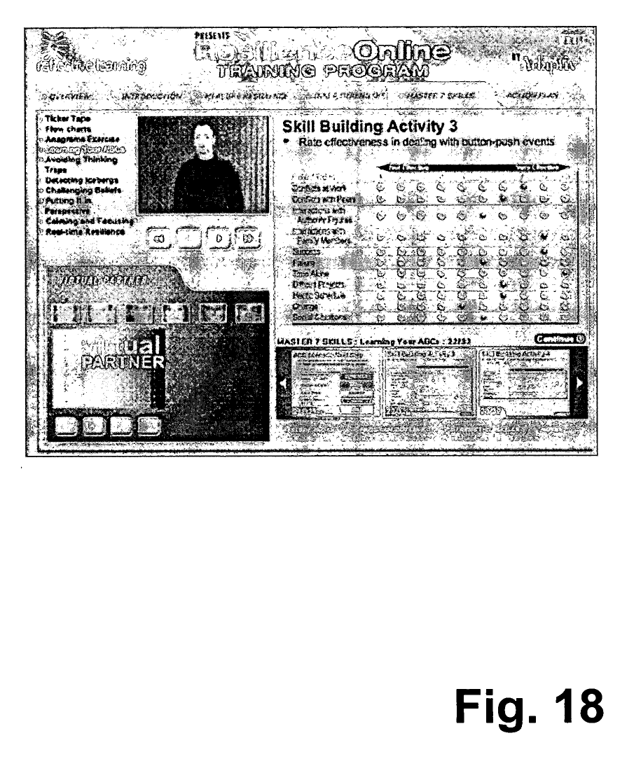

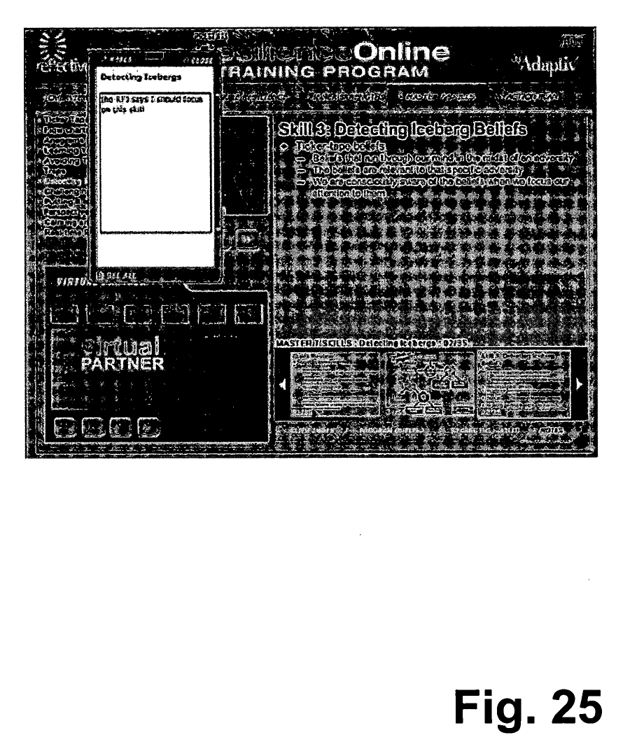

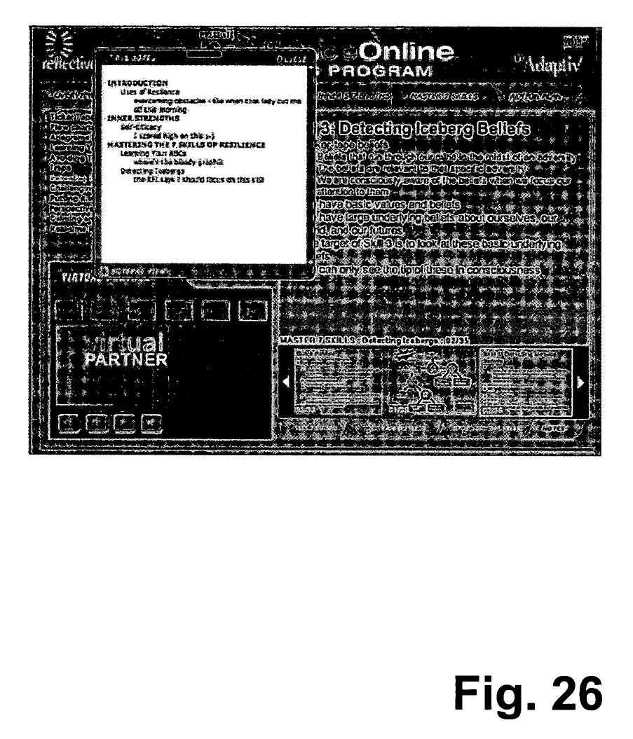

The exemplary computing application and user interface shown in FIGS. 6-26 is one example of how the herein described system and methods may be applied to implement interactive distance learning. This exemplary computing application provides exemplary features and operations (e.g., Resilience Program) which exemplifies one or more selected principals of higher education. Such principals can include, but are not limited to, descriptions found in the book entitled, The Resilience Factor: 7 Keys to Finding Your Inner Strength and Overcoming Life's Hurdles, by Drs. Karen Reivich and Andrew Shatte (Broadway Books 2003).

In an illustrative implementation, an exemplary computing application session is divided into the following segments: Introduction, Measure Resilience, Inner Strengths, Mastering 7 Skills and Action Plan. Each segment corresponds to one of the tabs (601, 602, 603, 604, 605) appearing along the top of the graphical user interface shown in FIGS. 6-26. By clicking on a particular tab, the participating user can access any desired segment of the Resilience Program.

A participating user initiates the introduction segment of the Resilience Program by clicking on the “Introduction” tab 601 on the graphical user interface. During this segment (depicted in FIGS. 6-10), the lecturer or discussion leader (who appears in box 610 of the graphical user interface) can deliver core content to the participating user which includes a definition of resilience, as well as a discussion of the need for resilience to overcome obstacles and challenges, steer through day-to-day adversities, and bounce back from major setbacks. During this segment, the lecturer or discussion leader also delivers core content describing the relationship between resilience and success.

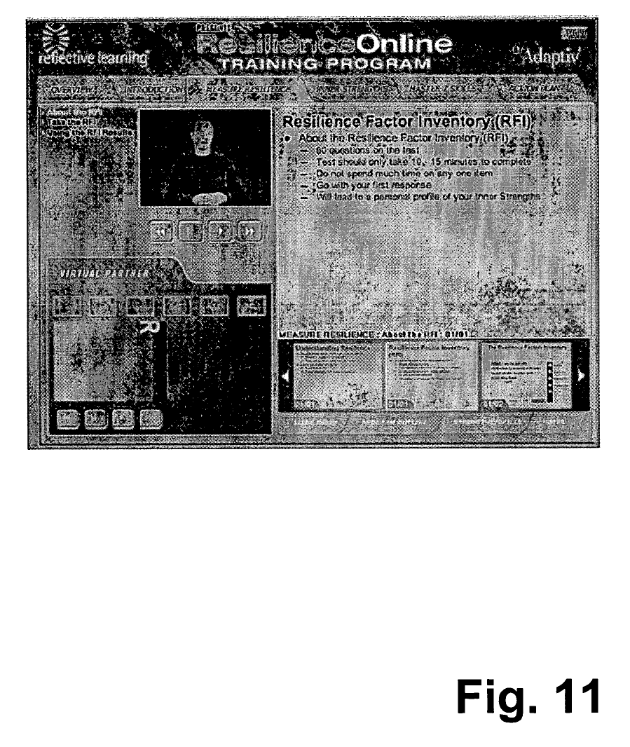

Following the introduction segment, a participating user may initiate the measure resilience segment of the Resilience Program by clicking on the “Measure Resilience” tab 602 on the graphical user interface. During this segment (depicted in FIGS. 11-14), the lecturer or discussion leader (who appears in box 610 of the graphical user interface) delivers core content to the participating user, which describes use of a Resilience Factor Inventory (RFI) to measure the participating user's own characteristics, or inner strengths, of resilience (the RFI is discussed more fully in The Resilience Factor, herein incorporated by reference.) During this segment, the lecturer or discussion leader also provides the participating user with feedback on the participating user's strengths and weaknesses. One goal of the core content delivered during this segment is to boost resilience by changing the way the participating user thinks about adversity.

Following the measure resilience segment, a participating user may initiate the inner strengths segment of the Resilience Program by clicking on the “Inner Strengths” tab 603 on the graphical user interface. During this segment, the lecturer or discussion leader (who appears in box 610 of the graphical user interface) delivers core content to the participating user, which describes the characteristics of resilience including emotion regulation (e.g., the ability to stay calm under pressure), impulse control (e.g., the ability to resist acting on first beliefs, or first reaction to a situation), causal analysis (e.g., the ability to accurately identify the causes of problems), self-efficacy (e.g., the belief that the participating user can solve the problems he/she is likely to experience, and that the participating user has faith in his/her ability to succeed), realistic optimism (e.g., the belief that things can be changed for the better), empathy (e.g., the ability to estimate what a person is feeling and predicting what he/she is likely to do), and reaching out (e.g., the ability to achieve significant meaning in life by going beyond oneself).

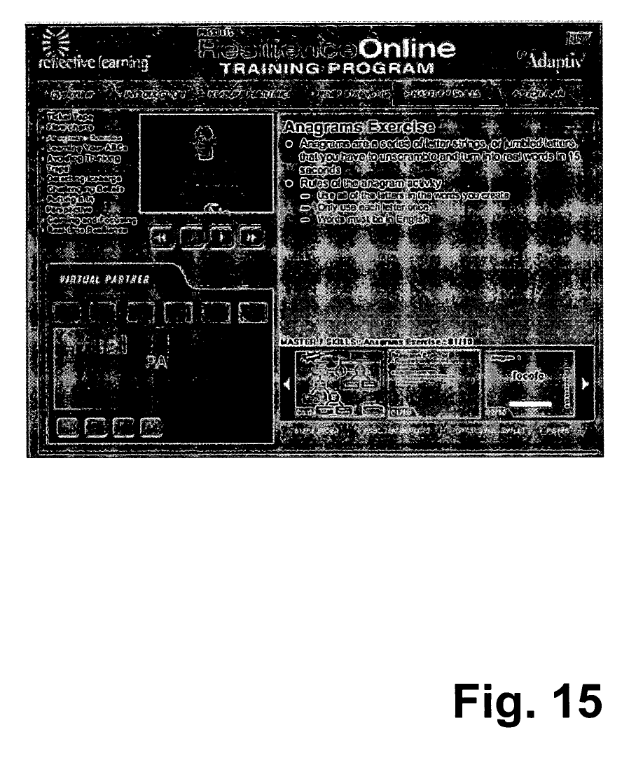

Following the inner strengths segment, a participating user may initiate the mastering skills segment (e.g., Mastering 7 skills) of the exemplary Resilience Program by segment (depicted in FIGS. 15-19), the lecturer or discussion leader (who appears in box 610 of the graphical user interface) delivers core content to the participating user relating to mastering the skills of resilience including: (1) learning one's ABCs (e.g., detecting one's thoughts when one is in the midst of an adversity), (2) avoiding thinking traps (e.g., identifying and avoiding errors or shortcuts in thinking), (3) detecting icebergs (e.g., uncovering deep or underlying beliefs about oneself, one's world and one's future), (4) challenging beliefs (e.g., testing the accuracy of one's beliefs about the causes of problems and changing them to find more accurate solutions that work), (5) putting it in perspective (e.g., learning to stop the ‘what-if’ belief so one is better prepared to deal with problems that really do exist or are most likely to occur), (6) calming and focusing (e.g., learning to stay calm and focused when one is overwhelmed by emotions or stress, so one can concentrate on the task at hand), and (7) real-time resilience (e.g., culmination skill that allows one to quickly change non-resilient, counter-productive thoughts into more accurate thoughts for immediate results).

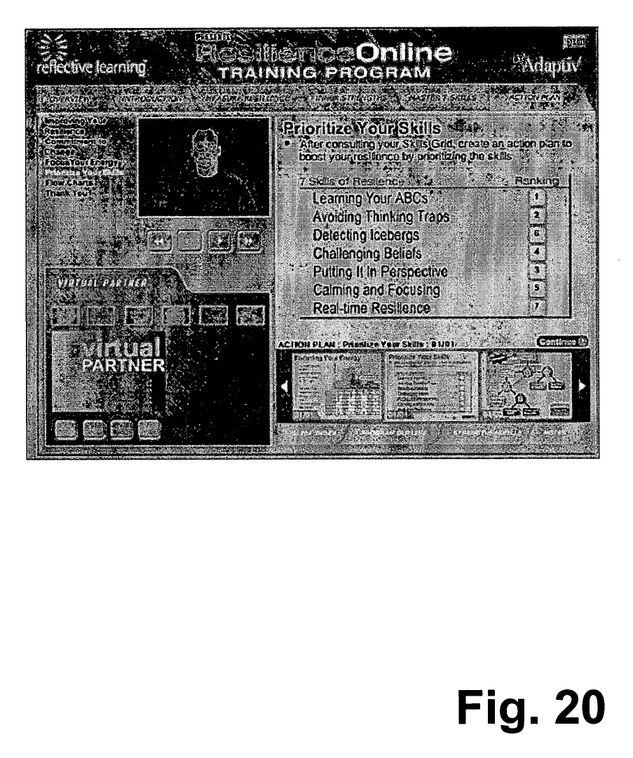

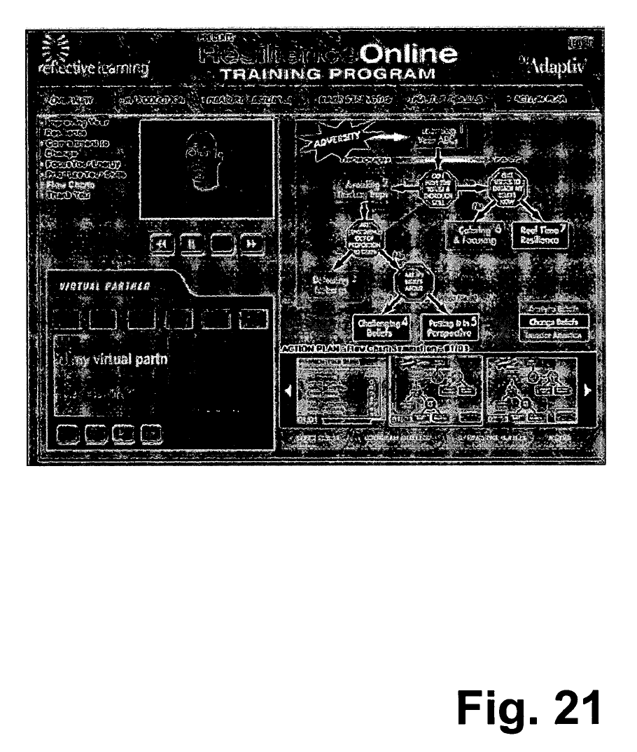

Following the Mastering 7 strengths segment, a participating user may initiate the action plan segment of the Resilience Program by clicking on the “Action Plan” tab 605 on the graphical user interface. During this segment (depicted in FIGS. 20-21), the lecturer or discussion leader (who appears in box 610 of the graphical user interface) delivers core content to the participating user relating to real life applications of the Resilience Program, reasons the participating user wants to make a change and the participating user's readiness to change, and making a commitment to change that will improve the participating user's life. The core content delivered in this segment assists the participating user in identifying which resilience skills the participating user needs most and creating an action plan to successfully implement desired changes.

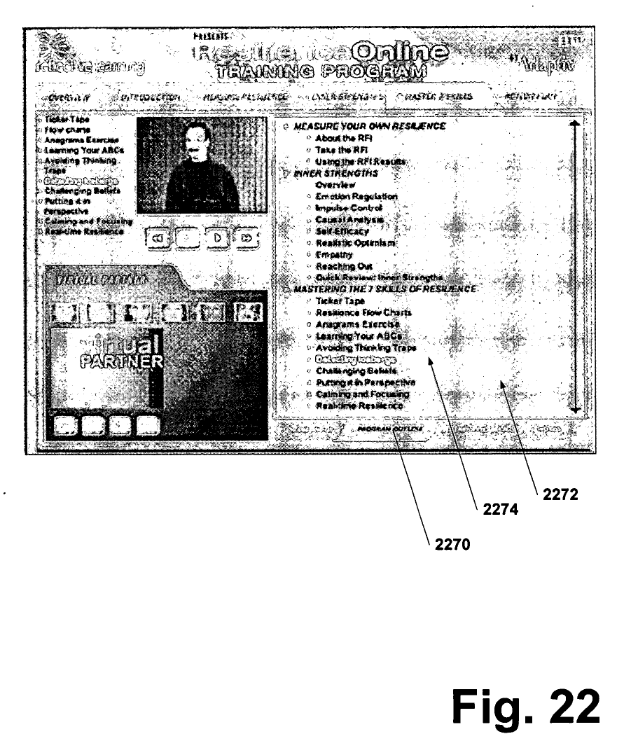

Referring now generally to FIGS. 6-26, during each segment of the program (e.g., exemplary computing session), the participating user can control the delivery of the core content by clicking on the rewind, pause, play and fast-forward buttons (620, 622, 624, and 626, respectively) positioned under the core content window 610 on the graphical user interface. In addition, by clicking on the Program Outline tab 2270, the participating user can view both an outline 2272 (shown in FIG. 22) of the core content for the entire program, and the participating user's current location 2274 in the core content of the program (the current location 2274 is preferably highlighted in the graphical user interface).

Also as shown generally in FIGS. 6-26, during each segment of the program, the graphical user interface presented to the participating user includes virtual partner window 630. Virtual partner window 630 includes a plurality of icons (631, 632, 633, 634, 635, 636), each of which corresponds to a potential partner for the participating user with respect to core content being delivered by the lecturer or discussion leader through window 610. During a segment of the core content relating to a particular skill building activity, a participating user may select one of the plurality of potential partners to assist the participating user with respect to core content delivered by the lecturer or discussion leader, by clicking on one of the icons 631, 632, 633, 634, 635, 636 on the graphical user interface. In addition, partner content may be provided in-line with core content without the participating user making a selection of a partner. In other words, the partner content may be provided together with the core content in a seamless session.

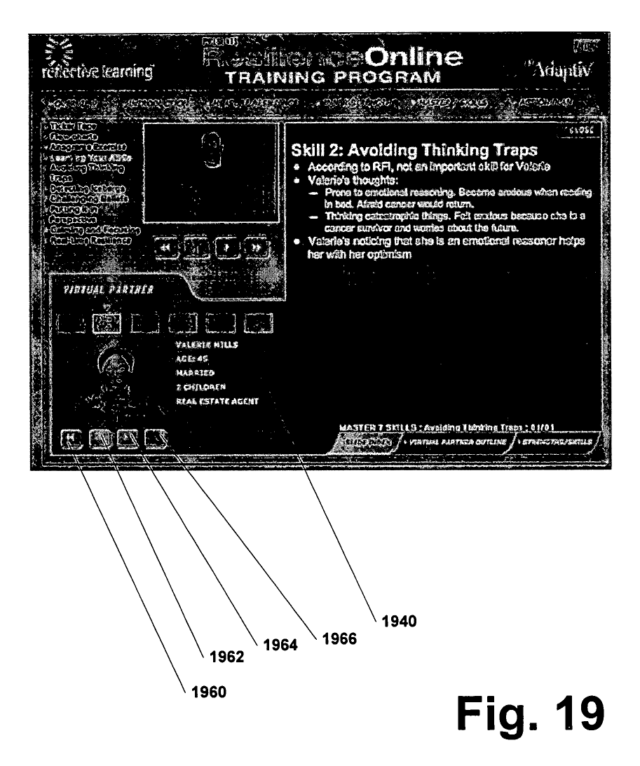

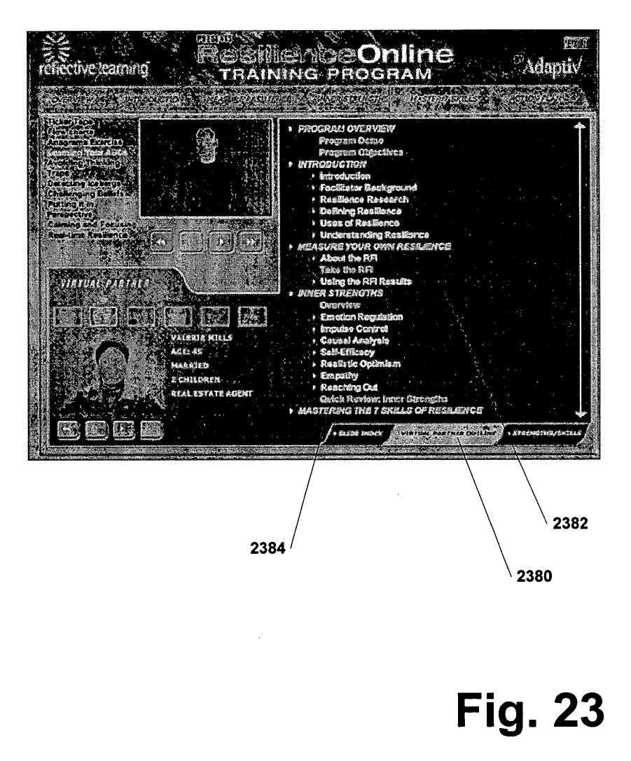

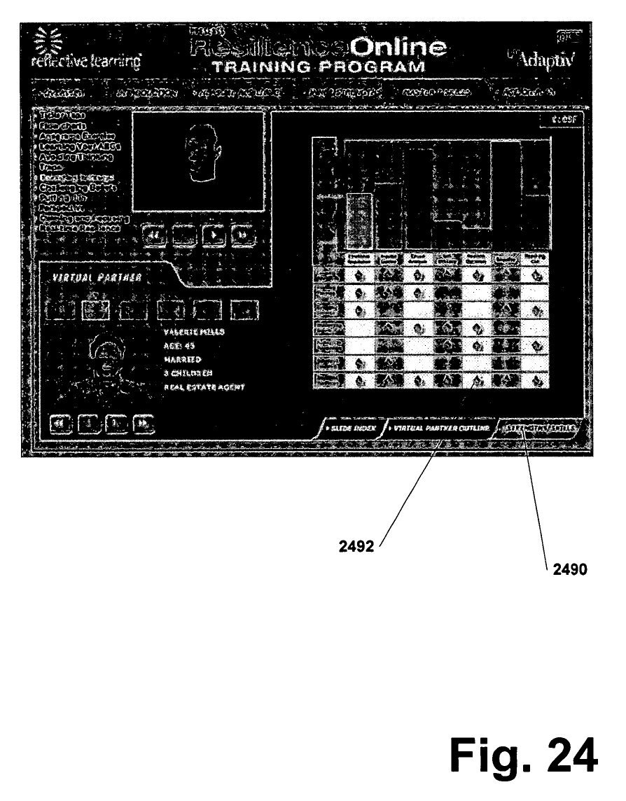

As shown more specifically in FIG. 19, the selected partner has past experience, characteristics, or is in a position that causes the participating user to identify with the selected partner with respect to the core content (such information about the selected partner is shown generally at location 1940 on the graphical user interface). In response to the selection of one of the potential partner icons by the participating user, content from the selected partner is delivered to the participating user via window 650 on the graphical user interface shown in FIG. 6. The content from the selected partner through window 650 corresponds to views or experience of the selected training partner with respect to the core content delivered by the lecturer or discussion leader, and may provide one or more different perspectives to reinforce material from the knowledge base already learned by the participating user. In one embodiment, when a participating user selects one of the potential partners by clicking on an icon 631-636, any core content that is then being delivered to the participating user via window 610 is automatically paused while the content from the selected partner is delivered to the participating user via window 650. After a partner icon 631-636 is selected by the participating user, the participating user can control the delivery of the content from the selected partner by clicking on the rewind, pause, play and fast-forward buttons (1960, 1962, 1964, and 1966, respectively of FIG. 19) positioned under the core content window 650 on the graphical user interface of FIG. 6. In addition, by clicking on the Virtual Partner Outline tab 2380 of FIG. 23, the participating user can view both an outline 2382 (shown in FIG. 23) of the content from the selected partner, and the participating user's current location 184 in the content from the selected partner (the current location 2384 is preferably highlighted in the graphical user interface). Moreover, after a partner icon 631-636 is selected by the participating user, the participating user can view the strengths/skills 2492 of the selected virtual partner by clicking on the strengths/skills tab 190, as shown in FIG. 24. By viewing the strengths/skills 2492 of the selected virtual partner the participating user can confirm the extent to which the participating user may identify with the virtual partner, and also understand that most people are not strong in all areas.

In an illustrative implementation, the content delivered to the participating user from the selected partner varies, based on both the potential partner selected by the participating user and the subject being addressed by the lecturer or discussion leader (via window 610 of FIG. 6) during the segment in which the participating user selects the potential partner.

Depending upon the topic or format of the core content, the potential partner selected by the participating user may correspond, for example, to a coach, an expert, a business professional, an employee, a supervisor, a military officer or a consumer. The potential partner may correspond to a virtual partner (asynchronous), or a person that the participating user interacts with remotely in real time (synchronous) during the education or training program.

The herein described systems and methods are preferably implemented over a computer network such as the Internet or a private network, or using other electronic platforms such as CD ROM platforms. In embodiments where prerecorded information is used for the core content and/or partner content, the prerecorded information along with software for implementing the program resides on a central server, which participating users access remotely over the network or locally using a CD ROM. In embodiments where live video feeds are used for the core content and/or partner content, the lecturer, discussion leader and/or partner delivering the live content may also access the central server remotely over the network. In such embodiments, the live content can initially be delivered to the central server, and then routed by the central server to participating users remotely over the network. Alternatively, a satellite feed of the lecturer, discussion leader and/or partner may be used for delivering the content to the participating users.

It will be understood by those skilled in the art that the particular training or education program shown in FIGS. 6-26, and the timing and sequence of the segments in the program as explained above, represent examples of particular embodiments of the herein described systems and methods, and should not be interpreted as limiting the scope of the present invention. The teachings of the herein described systems and methods may be applied to a myriad of training and educational topics, and application of the systems and methods disclosed herein to such other topics is considered to be within the scope of the present invention. It is understood, therefore, that the herein described systems and methods are not limited to the particular implementations disclosed, but is intended to cover modifications within the spirit and scope of the herein described systems and methods as defined in the appended claims.

In addition to the Resilience Program, the herein described system and methods may be applied to implement other interactive distance learning programs. For example, the Leadership Online Program, the Reflective Happiness Program, the Employee Excellence Program, the Reflected Best-Self Program, the Powerful Presenter Program, the Reflective Coaching Program, the Leadership Challenges Program, and the Coaching 4 Success Program.

In an illustrative operation, the Leadership Online Program is designed to help a participating user increase productivity and employee morale through leadership lessons and message delivery techniques that will become contagious throughout an organization. The Reflective Happiness Program is designed to dramatically decrease depression and increase happiness through self-assessments, positive psychology exercises, questions and answers, newsletters, book clubs and community forums. The Employee Excellence Program offers organizations a series of validated positive psychology exercises that have been demonstrated to significantly decrease depression and increase happiness, resulting in improvements in emotional and physical well-being, thus increasing employee productivity, job satisfaction and morale. The Reflective Coaching Program allows each participating user to be coached by a highly trained expert that gets to know the participating user. The Powerful Presenter Program helps a participating user systematically plan, create and deliver presentations with confidence and skill by providing the participating user practical, nuts and bolts skills, hundreds of useful tips used by master presenters, and solid foundational material every presenter needs. The Reflected Best-Self Program is a strength-based personal development tool that helps a participating user compose a best-self portrait by drawing on the perceptions of significant others who have unique and valuable insights into the strengths of the participating user. The Coaching 4 Success Program is designed to teach executive or managerial participating users (i.e., participating users who are executives or managers) how to accelerate performance and achieve success. The Leadership Challenges Program provides a flexible learning environment that is designed to help a participating user regarding decision making and life challenges.

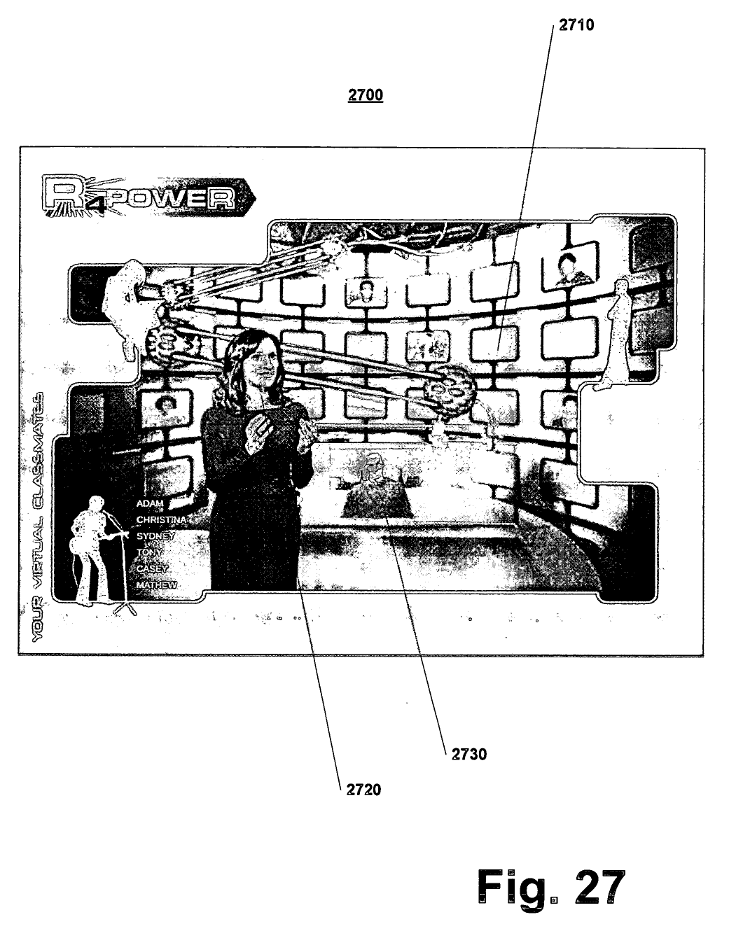

The exemplary computing application shown in FIG. 27 is one example of how the herein described system and methods may be applied to implement interactive distance learning directed to youth (i.e., a participating user who is a child or adolescent). This exemplary computing application (referred to hereafter as the R4Power Program) is a selected computing session (e.g., Resilience Program) specially designed for youth.

The R4Power Program is divided into the lessons: e.g., Lesson 1—You Are What You Think, Lesson 2—Becoming Flexible: Thinking Outside Your Box, Lesson 3—Getting to Accuracy Through Evidence: Fighting the Velcro/Teflon Effect, Lesson 4—Putting It In Perspective, Lesson 5—Real-time Resilience and Review of Skills, Lesson 6—Assertiveness, Lesson 7—Relaxation and Focusing Strategies, Lesson 8—Overcoming Procrastination, and Lesson 9—Decision Making.

The R4Power Program can be delivered to the participating user by an interactive virtual three dimensional environment 2700. The 2700 environment is designed to simulate the participating user's imagination and promote exploration. The 2700 environment comprises one or more possible display areas 2710 and one or more partner content display areas 2730. The lecturer or discussion leader 2720 delivers the core content to the participating user, and the 2710 display areas are utilized to display a variety of characters (referred to herein as “Virtual Classmates”), with whom the participating user can interact. The Virtual Classmates are part of a video-based peer-to-peer learning style that helps the participating user identify with, retain, and integrate information as they go through the program. In an illustrative implementation, Virtual Classmates can be actors whose characters are developed by psychologists. The Virtual Classmates are designed to provide a controlled environment so that the diverse backgrounds, individual strengths, emotional characteristics, challenges and examples of personal growth are more effectively illustrated.

In addition, display area 2730 can be utilized to deliver selected partner content. The partner in location 2730 delivering the partner content may be a guest celebrity or someone with whom the participating user can identify. In addition, the partner may share his or her own experience or examples relating to the R4Power Program lessons. Through the R4Power Program, participating users can learn to cope with struggles, such as parents losing a job or getting divorced, difficulties in school, conflicts with friends or family members, bullying, violence on TV, and hearing about wars or threats of terrorism. As a result, the R4Power Program helps boost resilience and inoculate youths against depression—a disease that has reached epidemic proportions.

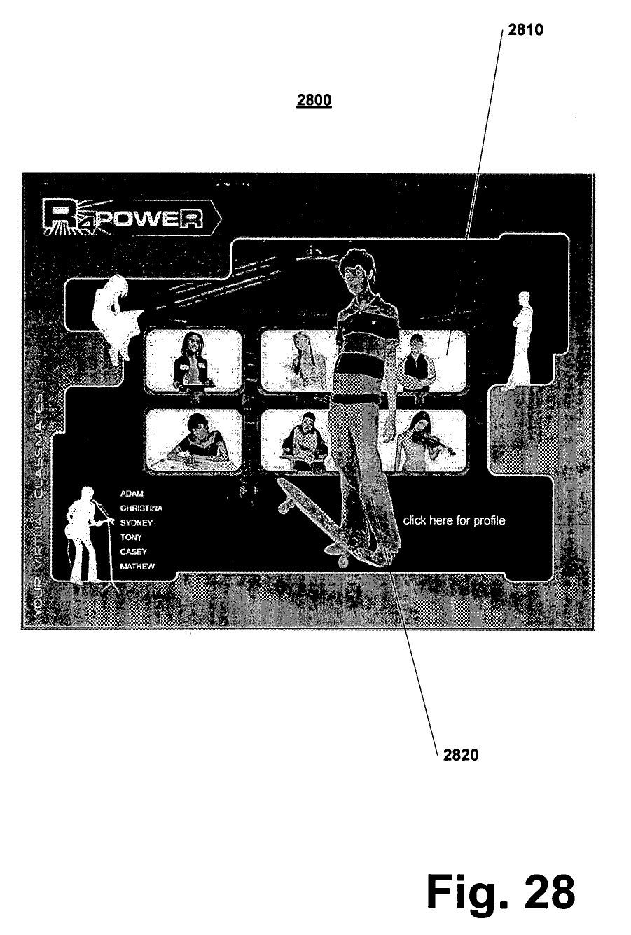

The exemplary computing application shown in FIG. 28 is one example of how the Virtual Classmates can interact with the participating user. The 2800 environment comprises one or more possible display areas 2810 and one or more partner content display areas 2820. The selected or corresponding Virtual Classmate 2820 delivers the partner content to the participating user, and the 2810 display areas are utilized to display a variety of Virtual Classmates, with whom the participating user can interact.

It is understood that the herein described systems and methods are susceptible to various modifications and alternative constructions. There is no intention to limit the invention to the specific constructions described herein. To the contrary, the invention is intended to cover all modifications, alternative constructions, and equivalents falling within the scope and spirit of the invention.

It should also be noted that the present invention may be implemented in a variety of computer environments (including both non-wireless and wireless computer environments), partial computing environments, and real world environments. The various techniques described herein may be implemented in hardware or software, or a combination of both. Preferably, the techniques are implemented in computing environments that maintain programmable computers that include a processor, a storage medium readable by the processor (including volatile and non-volatile memory and/or storage elements), at least one input device, and at least one output device. Computing hardware logic cooperating with various instructions sets are applied to data to perform the functions described above and to generate output information. The output information is applied to one or more output devices. Programs used by the exemplary computing hardware may be preferably implemented in various programming languages, including high level procedural or object oriented programming language to communicate with a computer system. Illustratively, the herein described apparatus and methods may be implemented in assembly or machine language. In any case, the language may be a compiled or interpreted language. Each such computer program is preferably stored on a storage medium or device (e.g., ROM or magnetic disk) that is readable by a general or special purpose programmable computer for configuring and operating the computer when the storage medium or device is read by the computer to perform the procedures described above. The apparatus may also be considered to be implemented as a computer-readable storage medium, configured with a computer program, where the storage medium so configured causes a computer to operate in a specific and predefined manner.

Although an exemplary implementation of the invention has been described in detail above, those skilled in the art will readily appreciate that many additional modifications are possible in the exemplary embodiments without materially departing from the novel teachings and advantages of the invention. Accordingly, these and all such modifications are intended to be included within the scope of this invention.

What is claimed is:

1. A system for electronic educational training comprising:
a core content data store;
a partner content data store; and
an education platform, comprising one or more instructions sets to associate partner content with core content and to provide core content and associated partner content to participating users through an interactive graphical user interface,
wherein the partner content comprises additional information and/or instructions regarding the core content.

2. The system as recited in claim 1, wherein the partner content is selected by a participating user through the interactive graphical user interface.

3. The system as recited in claim 1, wherein the education platform provides associated partner content in-line with core content as part of a content session.

4. The system as recited in claim 1, wherein the education platform provides core youth related educational content and associated youth related partner content through an interactive graphical user interface.

5. The system as recited in claim 1, wherein the education platform provides core and partner content regarding leadership, presentation, self esteem, motivation and life challenges.

6. The system as recited in claim 1, further comprising a computing environment.

7. The system as recited in claim 6, further comprising a networked computing environment.

8. The system as recited in claim 7, further comprising a computing application operating on the education platform providing the one or more instructions sets.

9. The system as recited in claim 4, wherein the interactive graphical user interface is provided as a virtual three dimensional environment.

10. The system as recited in claim 4,
wherein the education platform provides core youth related educational content and associated youth related partner content through real world or fictional characters selected by participating users and/or developed by psychologists.

11. A computer-implemented interactive method for educating or training one or more participating users on a topic, comprising:
providing a graphical user interface that delivers to the participating users content relating to the topic;
delivering, via the graphical user interface, core content from a lecturer or discussion leader to each participating user; and
delivering, via the graphic user interface, content from one or more partners regarding the core content to each participating user,
wherein the partner assists the participating user regarding the core content delivered by the lecturer or discussion leader.

12. The method as recited in claim 11, further comprising:
providing one or more icons on the graphical user interface, wherein each icon corresponds to a potential partner for the participating users with respect to core content delivered by the lecturer or discussion leader; and
during a segment of the core content, receiving a selection from a participating user, via the icons on the graphical user interface, of one or more partners; and in response to the selection by the participating user, delivering via the graphical user interface, content from the selected partner to the participating user regarding the core content.

13. The method as recited in claim 11, wherein the partner is selected from the group comprising coaches, experts, business professionals, employees, supervisors, military officers and consumers.

14. The method as recited in claim 11, wherein the potential partner is a virtual partner.

15. The method as recited in claim 11, wherein the potential partner is a person that the participating user interacts with remotely in real time during said education or training.

16. The method as recited in claim 11, wherein the core content is delivered to each participating user during one or more time segments covering one or more subjects included in the core content; and wherein the content delivered to the participating user varies based on the partner and the subject being addressed by the lecturer or discussion leader during the time segment.

17. The method as recited in claim 11, wherein the core content further comprises one or more skill building activities.

18. The method as recited in claim 11, wherein the content from the selected partner provides one or more different perspectives to reinforce material from the knowledge base previously provided to the participating user.

19. The method as recited in claim 11, further comprising:
providing a data store containing content regarding leadership, presentation, self esteem, motivation and life challenges.

20. The method as recited in claim 11, further comprising:
providing a data store containing youth directed content.

21. The method as recited in claim 20, further comprising:
selecting youth directed content through a graphical user interface.

22. The method as recited in claim 21, further comprising:
providing an interactive graphical user interface designed as a virtual three dimensional environment to view and interact with the youth directed content.

23. The method as recited in claim 22, further comprising:
selecting youth directed content that is provided through real world or fictional characters.

24. The method as recited in claim 23, further comprising:
providing youth directed content through real world or fictional characters comprising celebrities, athletes, characters selected by participating parties, and other characters developed by psychologists.

25. A computer readable medium that contains instructions which, when executed by a processor, causes the processor to perform an interactive method for educating or training one or more participating users on a topic, comprising the steps:
providing a graphical user interface that delivers content relating to the topic to the participating users;
delivering, via the graphical user interface, core content from a lecturer or discussion leader to each of the participating users, wherein the core content comprises a knowledge base to be delivered to the participating users; and
delivering, via the graphical user interface, partner content from one or more partners regarding the core content to each of the participating users, wherein the partner has past experience, characteristics or is in a position that causes the participating user to identify with the partner with respect to the core content,
wherein the partner assists the participating user with respect to the core content delivered by the lecturer or discussion leader, and
wherein the partner content corresponds to views or experience of the partner regarding the core content delivered by the lecturer or discussion leader.

26. The computer readable medium as recited in claim 25, further comprising:
providing one or more icons on the graphical user interface, wherein each icon corresponds to a potential partner for the participating users with respect to core content delivered by the lecturer or discussion leader;
during a segment of the core content, receiving a selection from a participating user, via the icons on the graphical user interface, of one or more partners; and
in response to the selection from the participating user, delivering via the graphical user interface, content from the selected partner to the participating user.

27. The computer readable medium as recited in claim 25, wherein the medium is a CD-ROM.

28. The computer readable medium as recited in claim 25 further comprising delivering, via the graphical user interface, partner content from one or more partners regarding the core content to each of the participating users in-line with the core content as part of a content session.

29. An interactive system for educating or training one or more participating users on a topic, comprising:
one or more participating user terminals that display a graphical user interface that delivers content relating to the topic to the participating users;
a central server or satellite that delivers, via the graphical user interface, core content from a lecturer or discussion leader and partner content from one or more partners to each participating user, and
wherein the partner assists the participating user regarding the core content delivered by the lecturer or discussion leader.

30. The interactive system as recited in claim 29,
wherein the graphical user interface includes one or more icons, wherein each icon corresponds to a potential partner for the participating users with respect to core content delivered by the lecturer or discussion leader;
wherein, during a segment of the core content, the central server or satellite receives a selection from a participating user, via the icons on the graphical user interface, of one or more partners; and
wherein, in response to the selection from the participating user, the central server or satellite delivers via the graphical user interface, content from the selected partner to the participating user regarding the core content.

31. A computer-implemented interactive method for receiving education or training on a topic, comprising:
receiving, via a graphical user interface, session content from a lecturer or discussion leader;
navigating session content delivered by the lecturer or discussion leader using one or more icons on the graphical user interface; and
receiving, via a graphical user interface, selected session content,
wherein the session content comprises partner content such that a selected partner assists the participating user regarding the session content delivered by the lecturer or discussion leader.

32. The method as recited in claim 31, further comprising:
during a segment of the session content, identifying a selection, via the icons on the graphical user interface, of one or more partners regarding the session content; and
receiving via the graphical user interface, session content from the selected partner.

33. The method as recited in claim 31, further comprising:
processing or understanding the core content and/or partner content; and
changing behavior regarding the core content and/or partner content.
